(19) United States
(12) Patent Application Publication
(10) Pub. No.: US 2025/0079731 A1
(43) Pub. Date: Mar. 6, 2025

(54) TERMINAL FITTING

(71) Applicant: Yazaki Corporation, Tokyo (JP)

(72) Inventors: Hirohito NAKATA, Shizuoka (JP); Ryosuke HARA, Shizuoka (JP)

(73) Assignee: Yazaki Corporation, Tokyo (JP)

(21) Appl. No.: 18/818,140

(22) Filed: Aug. 28, 2024

(30) Foreign Application Priority Data
Sep. 4, 2023 (JP) 2023-143031

(51) Int. Cl. H01R 11/16; H01R 43/02

(52) U.S. Cl. CPC H01R 11/16; H01R 43/0263

(57) ABSTRACT

A terminal fitting includes a contact part that allows part of a mating terminal to be connected thereto, and a joint part that is integral with the contact part and allows a core wire of an electric wire to be connected thereto through welding. The joint part is a V-shaped plate that includes a first inner surface and a second inner surface defining a bending angle which is an obtuse angle, and has a V-shaped cross-sectional shape orthogonal to a bending line. The first inner surface and the second inner surface are planar.

### CROSS REFERENCE TO RELATED APPLICATION

The present application is based on, and claims priority from the Japanese Patent Application No. 2023-143031, filed on Sep. 4, 2023, the entire contents of which are incorporated herein by reference.

### TECHNICAL FIELD

The disclosure relates to a terminal fitting.

### BACKGROUND

In a vehicle, such as an automobile, a terminal fitting attached to a terminal of an electric wire has been used as a component for connecting the electric wire to a predetermined part. JP 2015-111509 A discloses a technique relating to a terminal fitting where a core wire exposed at a terminal of an electric wire is joined using solder to a supporting surface that is a flat surface. In the terminal fitting disclosed in JP 2015-111509 A, a core wire is positioned with respect to a supporting surface by grasping a coating of an electric wire with an introduction groove, prior to joining the core wire.

### SUMMARY OF THE INVENTION

In the terminal fitting disclosed in JP 2015-111509 A, if, for example, an electric wire has a tendency to bend or fray before joining a core wire, it may not be possible to adjust the position of the core wire to a processing range for joining on a supporting surface. Thus, before joining the core wire, various processes are needed, such as correcting any fraying of the core wire, detecting a joining position using a camera, or correcting a position on the joining object side or the joining machine side. That is, there may be difficulties in the overall workability related to joining, such as an increase in working time or working cost related to joining the core wire.

An object of the disclosure is to provide a terminal fitting that improves workability during joining of a core wire of an electric wire.

A terminal fitting according to an embodiment includes a contact part that allows part of a mating terminal to be connected thereto, and a joint part that is integral with the contact part and allows a core wire of an electric wire to be connected thereto through welding, wherein the joint part is a V-shaped plate that includes a first inner surface and a second inner surface defining a bending angle which is an obtuse angle, and has a V-shaped cross-sectional shape orthogonal to a bending line, and the first inner surface and the second inner surface are planar.

In the above configuration, it is possible to provide a terminal fitting that improves workability during joining of a core wire of an electric wire.

### BRIEF DESCRIPTION OF THE DRAWINGS

FIG. 1A is a perspective view of a terminal fitting according to a first embodiment.

FIG. 1B is a rear view of the terminal fitting according to the first embodiment.

FIG. 2A is a plan view illustrating a state where a core wire is joined when an electric wire is in an ideal shape.

FIG. 2B is a plan view illustrating a state where a core wire is joined when an electric wire has a tendency to bend.

FIG. 2C is a plan view illustrating a state where a core wire is joined when there is fraying.

FIG. 3A is a cross-sectional view of a joint part on which a core wire is placed, when a bending angle is 100°.

FIG. 3B is a cross-sectional view of a joint part on which a core wire is placed, when the bending angle is 120°.

FIG. 3C is a cross-sectional view of a joint part on which a core wire is placed, when the bending angle is 160°.

FIG. 4 is a graph illustrating the amount of axial deviation of a core wire from a center plane with respect to the bending angle.

FIG. 5A is a perspective view of a terminal fitting according to a second embodiment.

FIG. 5B is a rear view of the terminal fitting according to the second embodiment.

FIG. 6A is a cross-sectional view of a joint part where a radius of curvature is one half of a conductor diameter of a core wire.

FIG. 6B is a cross-sectional view of a joint part where the radius of curvature is equal to the conductor diameter of the core wire.

FIG. 6C is a cross-sectional view of a joint part where the radius of curvature is one fourth of the conductor diameter of the core wire.

FIG. 7A is a cross-sectional view of a joint part before joining when the conductor diameter of the core wire is large.

FIG. 7B is a cross-sectional view of a joint part after joining when the conductor diameter of the core wire is large.

FIG. 8 is a perspective view of a metal plate material used as a material of a terminal fitting according to a third embodiment.

FIG. 9 is a perspective view of the terminal fitting according to the third embodiment.

### DETAILED DESCRIPTION OF THE INVENTION

Referring to the drawings, terminal fittings according to embodiments will be described in detail below. Note that dimensional ratios in the drawings are exaggerated for convenience of the description and are sometimes different from actual ratios.

### First Embodiment

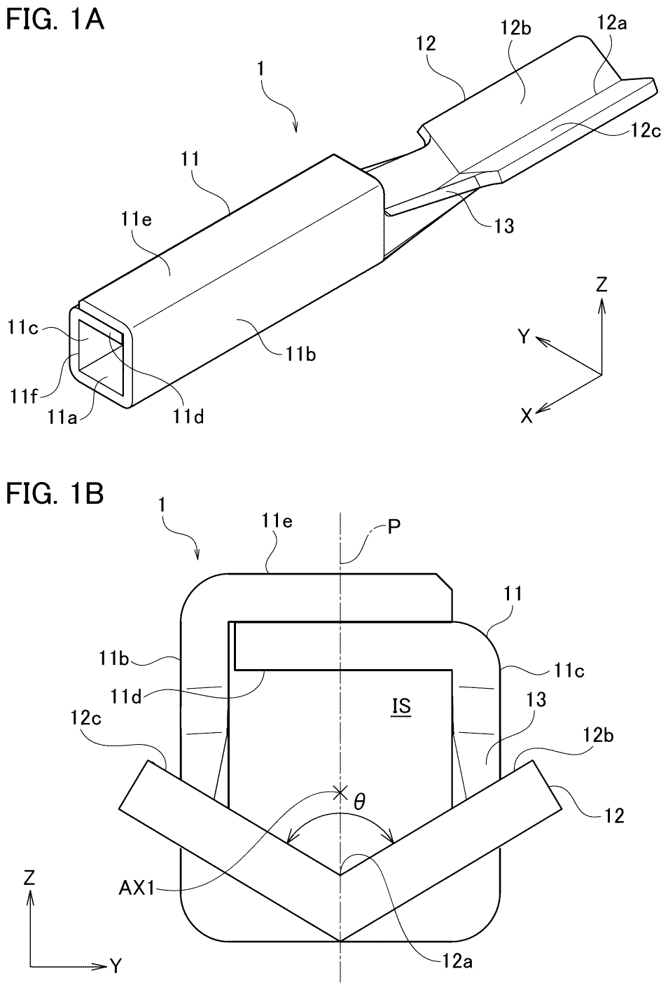

FIGS. 1A and 1B are diagrams illustrating a terminal fitting 1 according to a first embodiment. FIG. 1A is a perspective view of the terminal fitting 1. FIG. 1B is a rear view of the terminal fitting 1 when a joint part 12 side thereof is viewed along a direction extending along the terminal fitting 1.

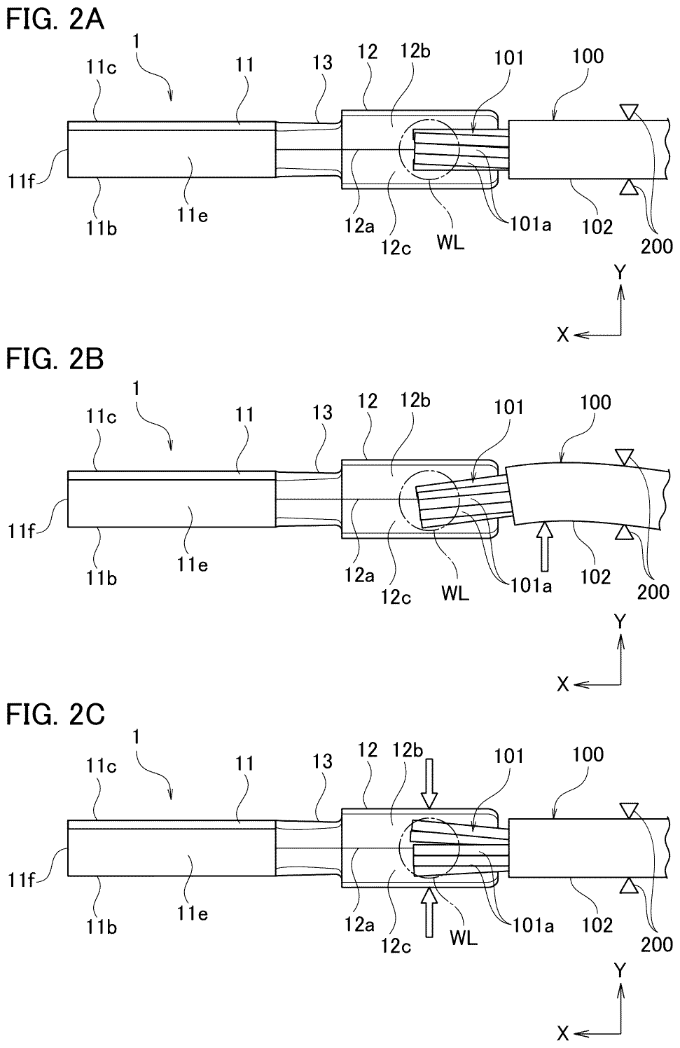

FIGS. 2A to 2C are plan views each exemplifying a state where a core wire 101 of an electric wire 100 is joined to the joint part 12 of the terminal fitting 1. FIG. 2A is a view illustrating a case where the electric wire 100 has what may be referred to as an ideal shape where the electric wire 100 does not have a tendency to bend, and the core wire 101 does not fray. FIG. 2B is a view illustrating a case where the electric wire 100 has a tendency to bend. FIG. 2C is a view illustrating a case where the core wire 101 frays. In FIGS. 2A to 2C, a support part 200 that supports an insulator 102 of the electric wire 100 in advance, before the core wire 101 is joined through welding, is schematically illustrated as a pair of triangles.

Generally, in a connector structure for connecting a male connector and a female connector, a male terminal can be provided on the male connector as a terminal fitting, and a female terminal can be provided on the female connector as a terminal fitting. The terminal fitting 1 according to the present embodiment is, as an example, a female terminal to which part of a male terminal, as a mating terminal, can be freely connected. The terminal fitting 1 can be attached to the core wire 101 exposed at the terminal of the electric wire 100, for example.

The electric wire 100 includes the core wire 101, which is a conductor, and the insulator 102, which covers the core wire 101. Note that there are no particular limitations on the type of the electric wire 100. For example, the electric wire 100 may be one of two lines of wiring in an electric wire that includes the wiring as differential wiring, such as a shielded twisted pair wire (STP). The core wire 101 is a stranded wire made by twisting multiple single wires 101a, such as tin-plated soft copper wires.

The terminal fitting 1 is manufactured by performing bending or the like on a plate that is formed by punching a conductive metal plate with a constant thickness into a predetermined shape. The terminal fitting 1 has a rod shape with an X direction taken as extending longitudinally, and includes a contact part 11, a joint part 12, and a linkage part 13 that are arranged as one body along the X direction. Two directions orthogonal to the X direction, and orthogonal to each other, will be referred to as a Y direction and a Z direction, below.

The contact part 11 allows part of the male terminal, which is a mating terminal, to be inserted. In the present embodiment, the contact part 11 has a rectangular-tube shape with the X direction as the axial direction, and with the outer periphery of a cross section orthogonal to the X direction being rectangular. Here, the cross section of the contact part 11 is parallel to both the Y direction, taken as a width direction, and the Z direction, taken as a height direction. Note that the contact part 11 having such a shape is sometimes called a “box part”. The contact part 11 has, as an example, a bottom plate 11a, a first side plate 11b, a second side plate 11c, an upper plate 11d, and a top plate 11e.

When the contact part 11 is processed into a product form, the top plate 11e, the first side plate 11b, the bottom plate 11a, the second side plate 11c, and the upper plate 11d are continuous about an axis based on the X-direction axis. The first side plate 11b rises in the height direction from one end of the bottom plate 11a in the Y direction. The second side plate 11c rises in the Z direction from the other end of the bottom plate 11a in the Y direction. That is, the first side plate 11b and the second side plate 11c are opposed to each other in the Y direction. The upper plate 11d is bent from an upper end of the second side plate 11c toward the first side plate 11b, and is opposed to the bottom plate 11a in the Z direction. The top plate 11e is bent from an upper end of the first side plate 11b toward the second side plate 11c to be opposed to the upper plate 11d, in close proximity to rest on top of one another in the Z direction. One end of the contact part 11 in the axial direction is an insertion port 11f into which part of the male terminal is inserted. The other end of the contact part 11 in the axial direction is continuous with the linkage part 13. In the present embodiment, as illustrated in FIG. 1B, a central axis AX1 of the terminal fitting 1 along the X direction is defined as an axis that passes approximately through the center of gravity of a cross section of an internal space IS in the contact part 11.

Note that in FIG. 1 and subsequent drawings, the shape of the contact part 11 is schematically illustrated. For example, the contact part 11 may have an elastic contact piece, on the inner surface of the bottom plate 11a, that elastically comes in contact with part of the male terminal inserted into the inner space IS, for electrical connection.

The shape of the contact part 11 is not limited to a rectangular-tube shape as described above, and may be, for example, a cylindrical shape having an axial direction along the X direction. Here, part of the open end of the cylindrical contact part 11 may be formed with a pair of elastic contact pieces.

The joint part 12 allows the core wire 101 of the electric wire 100 to be joined thereto through welding. In the present embodiment, the joint part 12 is integrated with the contact part 11 via the linkage part 13. The joint part 12 is a V-shaped plate that includes a first inner surface 12b and a second inner surface 12c defining a bending angle θ, with the X direction as a longitudinal direction, and has a V-shaped cross section orthogonal to a bending line 12a. The bending line 12a is along the X direction. The bending angle θ is an obtuse angle. The first inner surface 12b and the second inner surface 12c are planar. That is, the joint part 12 can be formed by performing bending processing on a flat plate part having a constant thickness at a preset bending angle θ with reference to the bending line 12a.

Here, as illustrated in FIG. 1B, an imaginary plane passing through the central axis AX1 and the bending line 12a, which are spaced apart from each other, is defined as a center plane P. The Z direction is parallel to the center plane P. The Y direction is orthogonal to the center plane P. Here, the first inner surface 12b and the second inner surface 12c are symmetrical with respect to the center plane P.

Further, as illustrated using double dash lines in FIGS. 2A to 2C, a welding processing range WL for joining the core wire 101 thereto through welding is set on the first inner surface 12b and the second inner surface 12c. At this point, the core wire 101 may be joined using laser welding as an example of melt joining. Here, when the core wire 101 in the welding processing range WL is irradiated with a laser beam, the temperature of the core wire 101 rises to generate molten balls, and then the joint part 12 is heated to join with the molten balls, so that the core wire 101 is joined to the joint part 12.

The linkage part 13 is positioned between the contact part 11 and the joint part 12, along the X direction, and links the contact part 11 and the joint part 12. In the present embodiment, since the width of the contact part 11, which has a rectangular-tube shape, in the Y direction is set smaller than the width of the joint part 12 in the Y direction, part of the linkage part 13 is formed in a tapered shape.

Next, the action and effect of the terminal fitting 1 will be described.

The terminal fitting 1 has the contact part 11, which allows part of the mating terminal to be connected thereto, and the joint part 12, which is integral with the contact part 11 and allows the core wire 101 of the electric wire 100 to be joined thereto through welding. The joint part 12 is a V-shaped plate that includes the first inner surface 12b and the second inner surface 12c defining the bending angle θ, which is an obtuse angle, and has a V-shaped cross section orthogonal to the bending line 12a. The first inner surface 12b and the second inner surface 12c are planar.

In the terminal fitting 1, when the core wire 101 is joined to the joint part 12, the core wire 101 is placed on the joint part 12 at a side where the first inner surface 12b and the second inner surface 12c are located, with the insulator 102 of the electric wire 100 supported by the support part 200.

Here, as illustrated in FIG. 2A, when the electric wire 100 has an ideal shape, the core wire 101 is properly positioned in the welding processing range WL at the time of being placed on the joint part 12, so that joining through laser welding or the like can be immediately started.

In contrast, when the electric wire 100 has a tendency to bend, if the joint part 12 is merely a flat plate part, the core wire 101 may protrude from the side of the assumed joint part 12 and deviate from the welding processing range WL. In this case, joining through laser welding or the like cannot be immediately started. If it is started, there is a possibility that a terminal fitting may be produced whose quality is not maintained.

In contrast, as illustrated in FIG. 2B, in the terminal fitting 1, when the electric wire 100 has a tendency to bend, the core wire 101 comes into contact with any of the inner surfaces during placement on the joint part 12. The inner surfaces are inclined toward the bending line 12a, that is, toward the center plane P. Note that in the example illustrated in FIG. 2B, the core wire 101 first comes into contact with the second inner surface 12c. Here, since the second inner surface 12c is planar, a centering effect acts on the core wire 101, which can be regarded as having a roughly circular section, and the core wire 101 moves in a direction indicated by a white arrow in FIG. 2B. Thus, even if the core wire 101 has a shape that may protrude from the side of the joint part 12 when being in contact with the second inner surface 12c, it is guided by the second inner surface 12c and appropriately positioned in the welding processing range WL.

Furthermore, when the core wire 101 frays, and the joint part 12 is merely a flat plate part, even if some of the single wires 101a constituting the core wire 101 are in the welding processing range WL, other single wires 101a may deviate from the welding processing range WL. Also in this case, joining through laser welding or the like cannot be started immediately, and if it is started, there is a possibility that a terminal fitting may be produced whose quality is not maintained.

In contrast, as illustrated in FIG. 2C, in the terminal fitting 1, when the core wire 101 frays, single wires 101a that have spread out come into contact with the first inner surface 12b or the second inner surface 12c, inclined toward the center plane P, when they are placed on the joint part 12. Thus, the single wires 101a, which have spread out, come together toward the center plane P in a direction indicated by a white arrow in FIG. 2C when they come into contact with the first inner surface 12b or the second inner surface 12c. That is, fraying is automatically corrected, and the core wire 101 is positioned to be properly positioned in the welding processing range WL.

As described above, in the terminal fitting 1, even when the electric wire 100 is bent or the core wire 101 frays, the core wire 101 is appropriately positioned in the welding processing range WL at the stage of being placed on the joint part 12. Thus, for example, before joining the core wire 101, there is no need for various processes in response to the above-described issues, such as correcting the fraying of the core wire 101, detecting the joining position using a camera, and correcting the position on the joining object side or the joining machine side. Thus, in the terminal fitting 1, an increase in working time or working cost for joining the core wire 101 can be avoided.

As described above, according to the present embodiment, it is possible to provide the terminal fitting 1 for improving workability during joining of the core wire 101 of the electric wire 100.

Further, in the terminal fitting 1, the bending angle θ may be set in such a manner that the core wire 101 comes into contact with the first inner surface 12b and the second inner surface 12c when placed on the joint part 12 in an orientation along the direction extending along the bending line 12a.

Here, in the above example, the direction extending along the bending line 12a corresponds to the X direction.

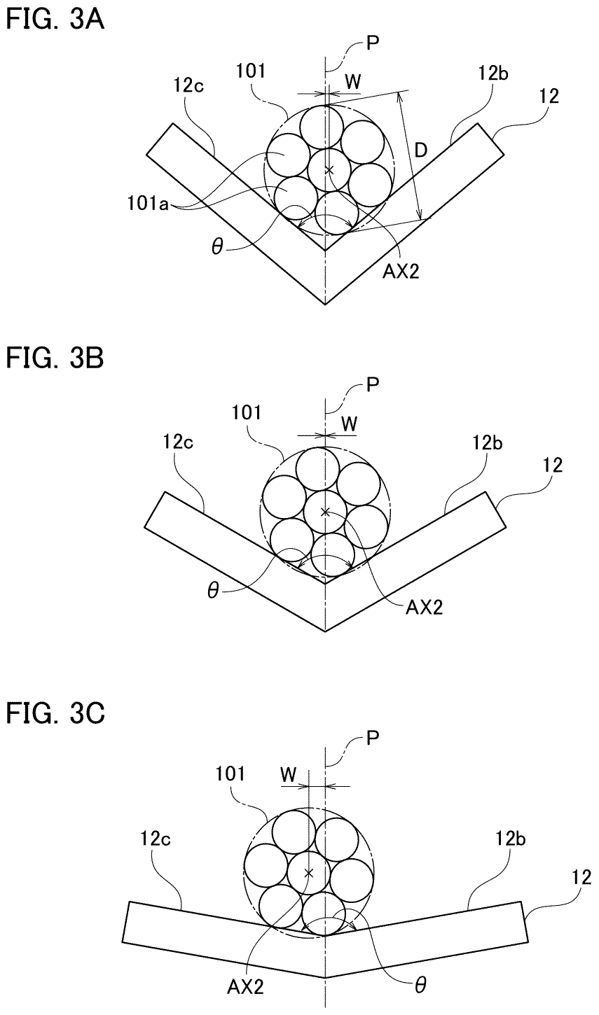

FIGS. 3A to 3C are cross-sectional views of joint parts 12 for illustrating derivation of a more suitable bending angle θ, assuming the electric wire 100 has a particular structure and dimensions. FIG. 3A is a view when the bending angle θ is set to 100°. FIG. 3B is a view when the bending angle θ is set to 120°. FIG. 3C is a view when the bending angle θ is set to 160°. The core wire 101 of the electric wire 100 illustrated here is a stranded wire including seven single wires 101a. One single wire 101a has an outer diameter of 0.16 mm. The core wire 101 has a conductor diameter D of 0.48 mm and is indicated by a double dash line in the figures. In FIGS. 3A to 3C, the core wire 101 is placed on the joint part 12 in an orientation along the X direction.

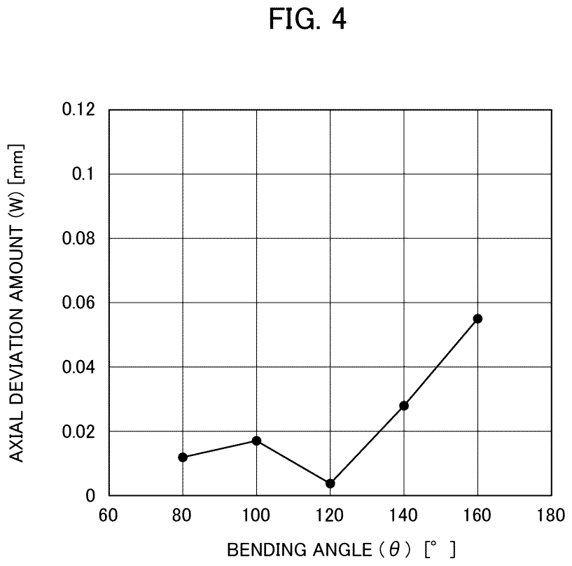

FIG. 4 is a graph illustrating an axial displacement amount W (in mm) with respect to the bending angle θ (in degrees), including results corresponding to FIGS. 3A to 3C. Here, as illustrated in FIGS. 3A to 3C, the central axis of the core wire 101 is defined as a central axis AX2. The axial displacement amount W is a displacement amount of the central axis AX2 from the center plane P.

First, as illustrated in FIG. 3A, when the bending angle θ is set to 100°, one single wire 101a is in contact with the first inner surface 12b, and another single wire 101a is in contact with the second inner surface 12c. At this time, the axial displacement amount W is approximately 0.017 mm.

Further, as illustrated in FIG. 3B, when the bending angle θ is set to 120°, as in the case of 100°, one single wire 101a is in contact with the first inner surface 12b, and another single wire 101a is in contact with the second inner surface 12c. At this time, the axial displacement amount W is approximately 0.004 mm, which is smaller than that in the case where the bending angle θ is set to 100°.

In contrast, as illustrated in FIG. 3C, when the bending angle θ is set to 160°, although one single wire 101a is clearly in contact with the first inner surface 12b, another single wire 101a is approximately on the bending line 12a and cannot be said to be clearly in contact with the second inner surface 12c. At this time, the axial displacement amount W is approximately 0.055 mm, which is larger than that in the cases where the bending angle θ is set at 100° or 120°. Since the outer diameter of one single wire 101a is 0.16 mm, the axial displacement amount W in this case is close to a value of 0.08 mm, which is the axial displacement amount W of one single wire 101a when it is regarded as being displaced laterally along the Y direction.

In addition, when the bending angle θ is set at 80°, the axial displacement amount W is approximately 0.012 mm. When the bending angle θ is set at 140°, the axial displacement amount W is approximately 0.028 mm. These cases follow the tendency of the above-described cases where values of the bending angle θ are approximated.

Thus, when the bending angle θ is set in such a manner that the core wire 101 comes into contact with both the first inner surface 12b and the second inner surface 12c when placed on the joint 12, the core wire 101 can be positioned in the more appropriate welding processing range WL, where the axial displacement amount W is small. In the example, it is preferable that the bending angle θ be set to around 120°.

### Second Embodiment

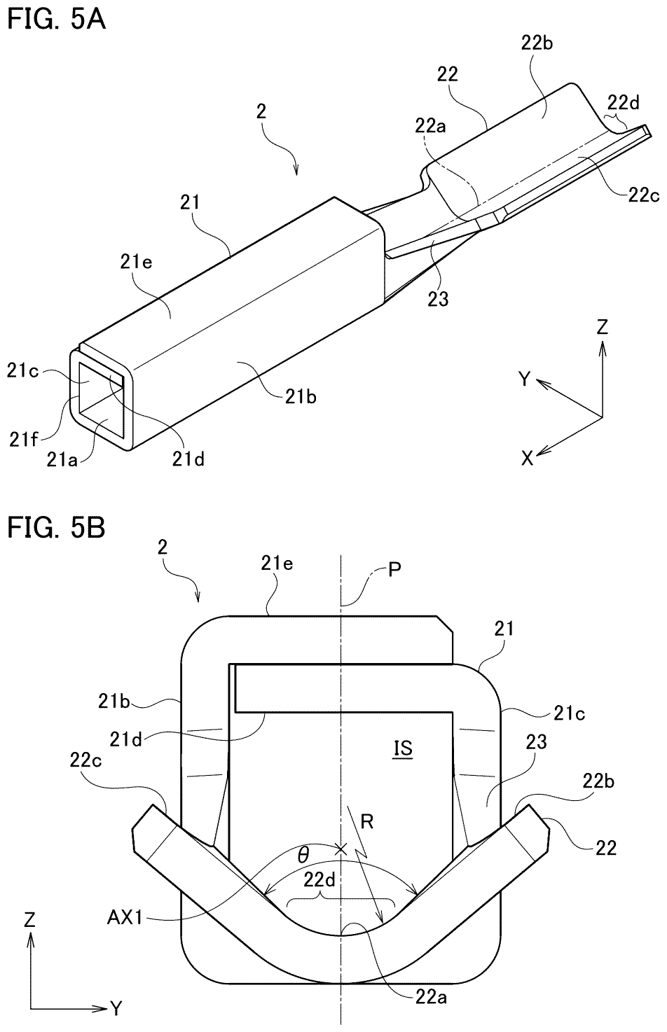

FIGS. 5A and 5B are views illustrating a terminal fitting 2 according to a second embodiment. FIG. 5A is a perspective view of the terminal fitting 2. FIG. 5B is a rear view of the terminal fitting 2 when a joint part 22 side is viewed along a direction extending along the terminal fitting 2.

The basic shape of the terminal fitting 2 corresponds to the shape of the terminal fitting 1. The terminal fitting 2 incudes a contact part 21, a joint part 22, and a linkage part 23. The shape of the contact part 21 is the same as the shape of the contact part 11 of the terminal fitting 1. That is, in the same manner as in the contact part 11, the contact part 21 also includes a bottom plate 21a, a first side plate 21b, a second side plate 21c, an upper plate 21d, and a top plate 21e. The shape of the linkage part 23 is the same as the shape of the linkage part 13 of the terminal fitting 1.

In contrast, in the same manner as in the joint part 12 of the terminal fitting 1, the joint part 22 includes a first inner surface 22b corresponding to the first inner surface 12b, and a second inner surface 22c corresponding to the second inner surface 12c, with respect to a bending line 22a corresponding to the bending line 12a. However, unlike the joint part 12, the joint part 22 includes a curved surface part 22d between the first inner surface 22b and the second inner surface 22c. The curved surface part 22d has a symmetrical shape with respect to the bending line 22a, while including the bending line 22a. That is, one side of the curved surface part 22d smoothly continues to the first inner surface 22b, and the other side of the curved surface part 22d smoothly continues to the second inner surface 22c. The radius of curvature of the curved surface part 22d is defined as a radius of curvature R below.

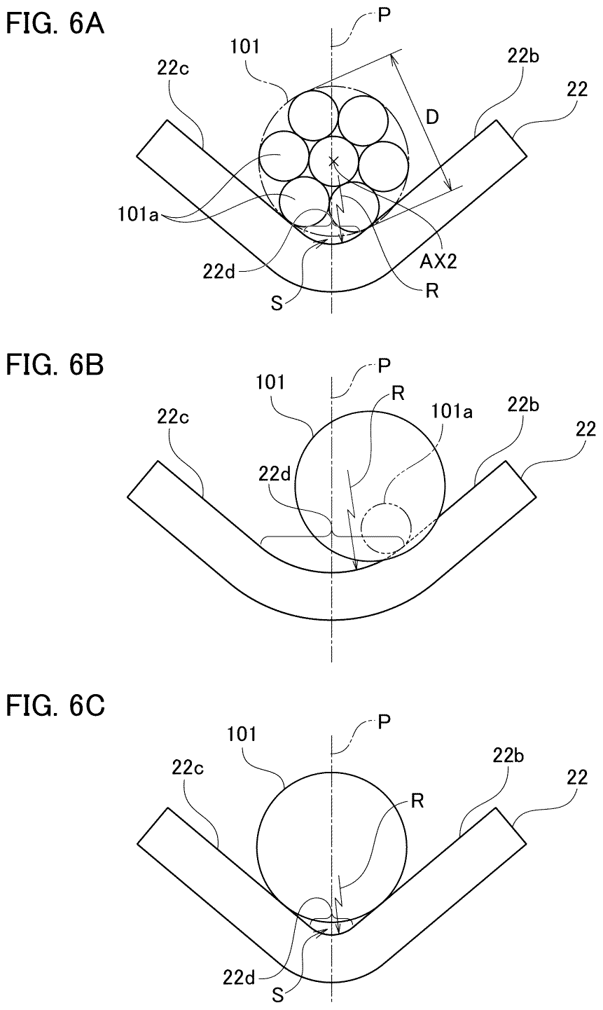

FIGS. 6A to 6C are cross-sectional views of joint parts 22 for illustrating derivation of a more appropriate radius of curvature R, assuming the electric wire 100 has a particular structure and dimensions. FIG. 6A is a view when the radius of curvature R is set to a value (D/2) of one half of the conductor diameter D. FIG. 6B is a view when the radius of curvature R is set to a value equal to the conductor diameter D. FIG. 6C illustrates a case where the radius of curvature R is set to a value (D/4) of one fourth of the conductor diameter D. The core wires 101 in the electric wires 100 illustrated here are the same as those illustrated in FIGS. 3A to 3C. In FIGS. 6A to 6C, the bending angle θ at each joint part 22 is unified to 120°. Note that in FIG. 6A, the core wire 101 placed on the joint part 12 in an orientation along the X direction is drawn in the same manner as in FIG. 3A, and in FIGS. 6B and 6C, only the conductor diameter D of the core wire 101 is schematically illustrated.

First, as illustrated in FIG. 6A, when the curvature radius R is set to a value of one half of the conductor diameter D, one single wire 101a is in contact with the first inner surface 22b, and another single wire 101a is in contact with the second inner surface 22c. Thus, in the terminal fitting 2, a centering effect acts on the core wire 101 in the same manner as the effect in the terminal fitting 1 according to the first embodiment, so that the core wire 101 can be appropriately positioned in the welding processing range WL.

In addition, in the terminal fitting 2, as described above, the joint part 22 may include the curved surface part 22d between the first inner surface 22b and the second inner surface 22c, which includes the bending line 22a, and which has a symmetrical shape with respect to the bending line 22a.

According to the terminal fitting 2, as illustrated in FIG. 6A, when the core wire 101 is placed on the joint part 22, a gap space S between the core wire 101 and the curved surface part 22d becomes smaller. Thus, when the core wire 101 is joined to the joint part 22 through welding, fitting between the core wire 101 and the joint part 22 is improved more than in the case of the terminal fitting 1, and consequently, a decrease in shear tensile strength can be avoided.

In contrast, as illustrated in FIG. 6B, when the radius of curvature R is set to the value of the conductor diameter D, that is, when the radius of curvature R is larger than that in the case of FIG. 6A, a situation may arise where none of the single wires 101a contacts either the first inner surface 22b or the second inner surface 22c. Since the centering effect does not occur on the core wire 101, this case is undesirable in that the core wire 101 cannot be properly positioned in the welding processing range WL.

Furthermore, as illustrated in FIG. 6C, when the radius of curvature R is set to one fourth of the conductor diameter D, that is, when the radius of curvature R is smaller than that in the case of FIG. 6A, one single wire 101a is in contact with the first inner surface 22b, and another single wire 101a is in contact with the second inner surface 22c. Thus, in the terminal fitting 2, since the centering effect acts on the core wire 101, the core wire 101 can be properly positioned in the welding processing range WL. However, in this case, when the core wire 101 is placed on the joint part 22, the gap space S does not become relatively smaller. Thus, when the core wire 101 is joined to the joint part 22 through welding, the effect of improving fitting between the core wire 101 and the joint part 22 is slight.

Thus, in the terminal fitting 2, where D is the conductor diameter of the core wire 101, and R is the radius of curvature of the curved surface part 22d, the radius of curvature may satisfy a condition of (D/4)<R<D.

In the terminal fitting 2, it is possible to improve the fitting between the core wire 101 and the joint part 22 when the core wire 101 is properly positioned in the welding processing range WL, and the core wire 101 is joined to the joint part 22 through welding.

Note that the description so far has been made by using an example where the conductor diameter D of the core wire 101 of the electric wire 100 is 0.48 mm. However, the terminal fitting 1, and the like, according to each embodiment can also be applied to electric wire 100 having different sizes, with the core wire 101 having a conductor diameter D larger than 0.48 mm, or with the core wire 101 having a conductor diameter D smaller than 0.48 mm, as long as various conditions are satisfied.

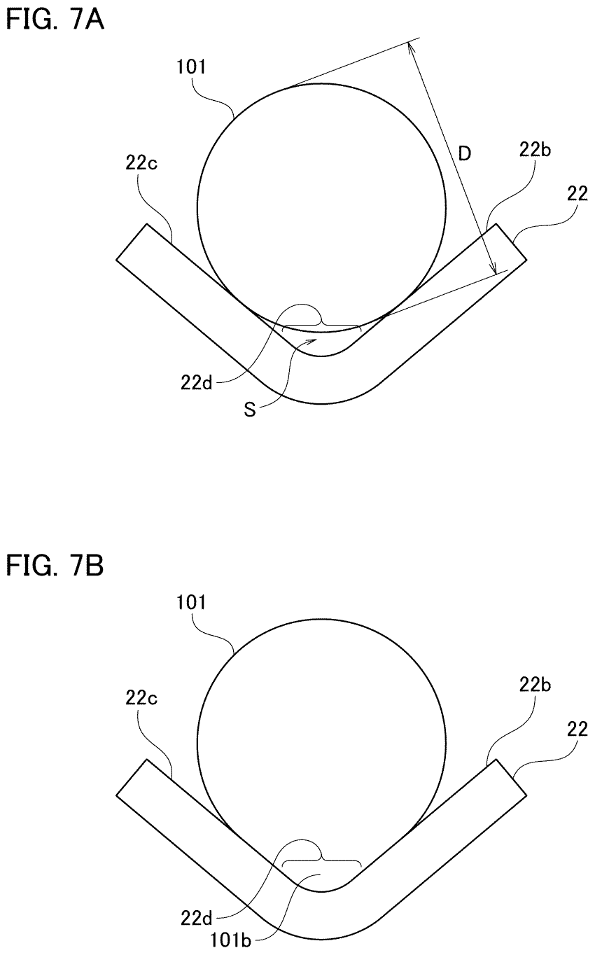

For example, the shape of the terminal fitting 2 according to the second embodiment is advantageous for connecting the electric wire 100 when the core wire 101 has a conductor diameter D larger than 0.48 mm. In this case, as illustrated in FIG. 7A, the radius of curvature R is equal to that in FIG. 6A, and when the core wire 101 is placed on the joint part 22, the gap space S between the core wire 101 and the curved surface part 22d is relatively wide. However, when the core wire 101 is joined to the joint part 22 through welding, as illustrated in FIG. 7B, the volume of molten balls becomes larger, so that the molten balls flow into the gap space S and consequently fill the gap space S. Thus, the core wire 101 and the joint part 22 do not have insufficient fitting, and consequently, the shear tensile strength may not decrease.

### Third Embodiment

In each of the above embodiments, a metal plate having a constant thickness is used as a material to form both the terminal fitting 1 and the terminal fitting 2. In contrast, in the present embodiment, a metal plate material 300 having different thicknesses according to respective parts of a terminal fitting, instead of having a constant thickness, is employed as a material of the terminal fitting. Hereinafter, a case of manufacturing a terminal fitting with a shape similar to that of the terminal fitting 2 according to the second embodiment, using the metal plate material 300 as the material will be exemplified. Thus, the same reference numerals are given to the same components as those of the terminal fitting 2 according to the second embodiment, and the description thereof will be omitted.

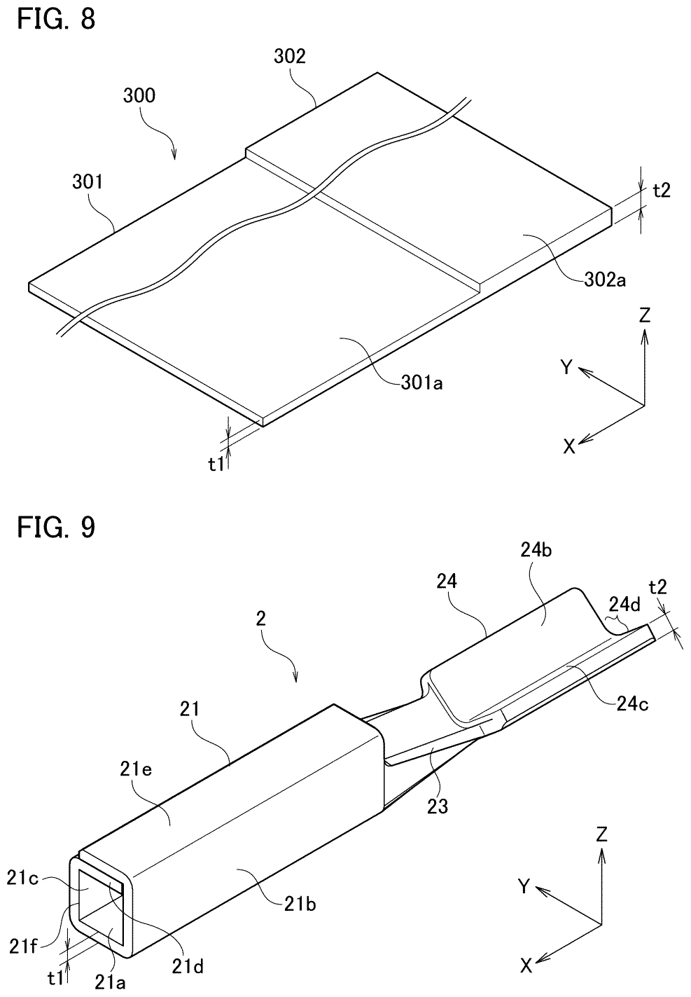

FIG. 8 is a perspective view of the metal plate material 300. The metal plate material 300 includes a first plate part 301 set to a first thickness t1, and a second plate part 302 set to a second thickness t2. The first plate part 301 and the second plate part 302 are continuous in series along the X direction aligned with the direction extending from the terminal fitting 2. The first plate part 301 is a part where the contact part 21 and the linkage part 23 of the terminal fitting 2 are formed. The second plate part 302 is a part where the joint part 24 of the terminal fitting 2 is formed. The second thickness t2 is thicker than the first thickness t1. Here, one surface of the first plate part 301 is defined as a first surface 301a. In the present embodiment, the second thickness t2 of the second plate part 302 is set in such a manner that a second surface 302a facing in the same direction as the first surface 301a is one step higher than the first surface 301a in the Z direction.

FIG. 9 is a perspective view of a terminal fitting 2 according to the third embodiment, manufactured from the metal plate material 300. The terminal fitting 2 according to the present embodiment includes the contact part 21, the joint part 24 instead of the joint part 22 of the second embodiment, and the linkage part 23. The joint part 24 includes a first inner surface 24b, and a second inner surface 24c in the same manner as in the joint part 22 in the second embodiment. The joint part 24 also includes a curved surface 24d between the first inner surface 24b and the second inner surface 24c.

In the manufacturing stage of the terminal fitting 2, a part that will become the contact part 21 and the linkage part 23 is punched in a portion of the first plate part 301, and at the same time, a part that will become the joint part 24 is punched in a portion of the second plate part 302. Then, the punched plate is subjected to bending or the like to finally manufacture the terminal fitting 2. At this time, a surface that was the first surface 301a of the first plate part 301 becomes the inner surface of the contact part 21, and at the same time, a surface that was the second surface 302a of the second plate part 302 becomes the first inner surface 24b, or the second inner surface 24c, of the joint part 24. Comparing the terminal fitting 2 according to the present embodiment with the terminal fitting 2 according to the second embodiment illustrated in FIG. 5A, the thicknesses of the contact part 21 and the linkage part 23 are common to the first thickness t1. In contrast, the thickness of the joint part 22 in the terminal fitting 2 according to the second embodiment is the same as the first thickness t1, while in the terminal fitting 2 according to the present embodiment, the first inner surface 24b and the second inner surface 24c are thicker moving inward. For example, when a core wire 101 having a conductor diameter D of 0.48 mm is to be joined, the first thickness t1 may be set to about 0.15 mm, and the second thickness t2 may be set to about 0.3 mm.

Thus, in the terminal fitting 2 according to the present embodiment, when the thickness of the first plate part 301 as a plate part forming the contact part 21 is defined as the first thickness t1, and the thickness of the joint part 24 is defined as the second thickness t2, the second thickness t2 may be thicker than the first thickness t1.

In the terminal fitting 2, since the first thickness t1 of the first plate part 301 forming the contact part 21 can be set equal to that of a general terminal fitting, compatibility conditions for the terminal fitting 2 as a product are not narrowed. In contrast, in the present embodiment, joining of the core wire 101 to the joint part 24 is assumed to be through melt joining, such as laser welding, as in each of the above embodiments. Thus, in the terminal fitting 2, since the second thickness t2 of the joint part 24 is set to be thicker than the first thickness t1, restriction of welding conditions due to thinness can be eased, and compatibility conditions of the terminal fitting 2 as a product can be widened.

In the present embodiment, the second thickness t2 of the joint part 24 is thicker than the first thickness t1 so that the first inner surface 24b and the second inner surface 24c are more inward, as illustrated in FIG. 9. In this case, the outer surface part of the joint part 24, opposite to the first inner surface 24b and the second inner surface 24c, is not different in shape from the same part of the terminal fitting 2 according to the second embodiment illustrated in FIG. 5A. That is, since the joint part 24 is not enlarged outward, there is an advantage that compatibility conditions of the terminal fitting 2 as a product cannot be narrowed. In contrast, if compatibility conditions of the terminal fitting 2 are not narrowed, the second thickness t2 may be set in such a manner that the outer surface of the joint part 24 is more outward than that illustrated in FIG. 5A.

Note that in the present embodiment, the metal plate material 300 is used as a material to manufacture a terminal fitting having the shape of the terminal fitting 2 according to the second embodiment. The metal plate material 300 can also be used to manufacture a terminal fitting having the shape of the terminal fitting 1 according to the first embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A terminal fitting, comprising:
a contact part that allows part of a mating terminal to be connected thereto; and
a joint part that is integral with the contact part and allows a core wire of an electric wire to be connected thereto through welding, wherein
the joint part is a V-shaped plate that includes a first inner surface and a second inner surface defining a bending angle which is an obtuse angle, and has a V-shaped cross-sectional shape orthogonal to a bending line, and
the first inner surface and the second inner surface are planar.

2. The terminal fitting according to claim 1, wherein the bending angle is set in such a manner that the core wire comes into contact with the first inner surface and the second inner surface when placed on the joint part in an orientation along a direction extending along the bending line.

3. The terminal fitting according to claim 2, wherein the joint part includes, between the first inner surface and the second inner surface, a curved surface part that includes the bending line and has a symmetrical shape with respect to the bending line.

4. The terminal fitting according to claim 3, wherein when a conductor diameter of the core wire is D, and a radius of curvature of the curved surface part is R,
the radius of curvature satisfies a condition of (D/4)<R<D.

5. The terminal fitting according to claim 1, wherein when a thickness of a plate part forming the contact part is defined as a first thickness, and a thickness of the joint part is defined as a second thickness,
the second thickness is thicker than the first thickness.
